(19) United States
(12) Patent Application Publication
(10) Pub. No.: US 2018/0075254 A1
(43) Pub. Date: Mar. 15, 2018

(54) AUTOMATED CLASSIFICATION AND DETECTION OF SENSITIVE CONTENT USING VIRTUAL KEYBOARD ON MOBILE DEVICES

(71) Applicant: Titus Inc., Ottawa (CA)

(72) Inventors: Paul Reid, Brockville (CA); Charlie Pulfer, Ottawa (CA)

(21) Appl. No.: 15/558,814

(22) PCT Filed: Mar. 16, 2016
(86) PCT No.: PCT/CA2016/050294

§ 371 Date: Sep. 15, 2017

Related U.S. Application Data
(60) Provisional application No. 62/133,846, filed on Mar. 16, 2015.

(51) Int. Cl. G06F 21/62; G06F 17/30; G06F 17/27

(52) U.S. Cl. CPC G06F 21/6245; G06F 17/30707; G06Q 30/0633; G06F 17/2705; G06F 17/2785

(57) ABSTRACT

A system and method for identifying sensitive information on a mobile device is provided. A virtual keyboard is presented in an text editing application on the mobile device. As content is entered in the application receives or determines classification suggestions which are presented in the virtual keyboard which is dynamically modified. A classification can then be applied to the content identifying sensitive information within the e-mail or document.

### CROSS-REFERENCE TO RELATED APPLICATIONS

This application claims priority from U.S. Provisional Application No. 62/133,846 filed Mar. 16, 2015, the entirety of which is incorporated for all purposes.

### TECHNICAL FIELD

The present disclosure relates to user interfaces on mobile devices and in particular classification of content generated on the mobile device.

### BACKGROUND

Communications that used to happen face to face now most frequently take place over information networks. With these interactions happening virtually, the propensity for inadvertent disclosure of information is greater. Users do not realize that information that they are creating can sometimes be lost, incorrectly forwarded, or stolen, which can lead to embarrassment, lawsuits etc. The most common method of input on mobile devices such as smartphones and tablets is the virtual keyboard. The virtual keyboard is typically used to enter letters and symbols in various alphabets. The virtual keyboard is already used to communicate spelling errors or spelling assistance to the user. Classification of electronic communications can be difficult to perform. Therefore there is a need for an improved system and method of classifying electronic communications from mobile devices.

### BRIEF DESCRIPTION OF THE DRAWINGS

Further features and advantages of the present disclosure will become apparent from the following detailed description, taken in combination with the appended drawings, in which:

FIG. 1 shows a representation of system for automated classification;

FIG. 2 shows a mobile device displaying having sensitive information;

FIG. 3 shows a system for automated classification and sensitive information detection;

FIG. 4 shows a mobile device display showing a classification selection bar;

FIG. 5 shows a mobile device display showing changes in classification when PII is detected;

FIG. 6 shows providing further selections from a classification banner;

FIG. 7 shows a virtual keyboard for classification selections;

FIG. 8 shows selection of a favourite classification on a keyboard;

FIG. 9 shows icons for classification selection;

FIG. 10 shows a tag cloud for classification selection;

FIG. 11 shows a method of sensitive information detection and classification on a mobile device; and

FIG. 12 shows a method of sensitive information classification generation.

It will be noted that throughout the appended drawings, like features are identified by like reference numerals.

### DETAILED DESCRIPTION

In accordance with an aspect of the present disclosure there is provided a method of content classification on a mobile device comprising: receiving content in a text editing application executed on the mobile device for generating a message or document; determining one or more classifications associated with sensitive information presented in the content; modifying a virtual keyboard displayed within the text editing application based upon the determined one or more classifications; applying at least one of the one or more classifications to the content.

In accordance with another aspect of the present disclosure there is provided a classification engine comprising: a classification database containing a plurality of classifications, each classification associated with a keyword or content pattern; and a processing engine for receiving content from a mobile device and determining classifications associated with the content using a classification dictionary the classifications for presentation in a virtual keyboard to be associated with the content.

In accordance with yet another aspect of the present disclosure there is provided a method of content classification comprising: receiving content generated from text input on a mobile device; parsing the content for keywords or content patterns; determining classifications associated with the keyword or content patterns; providing the classifications to the mobile device for display in a virtual keyboard to be associated with the content.

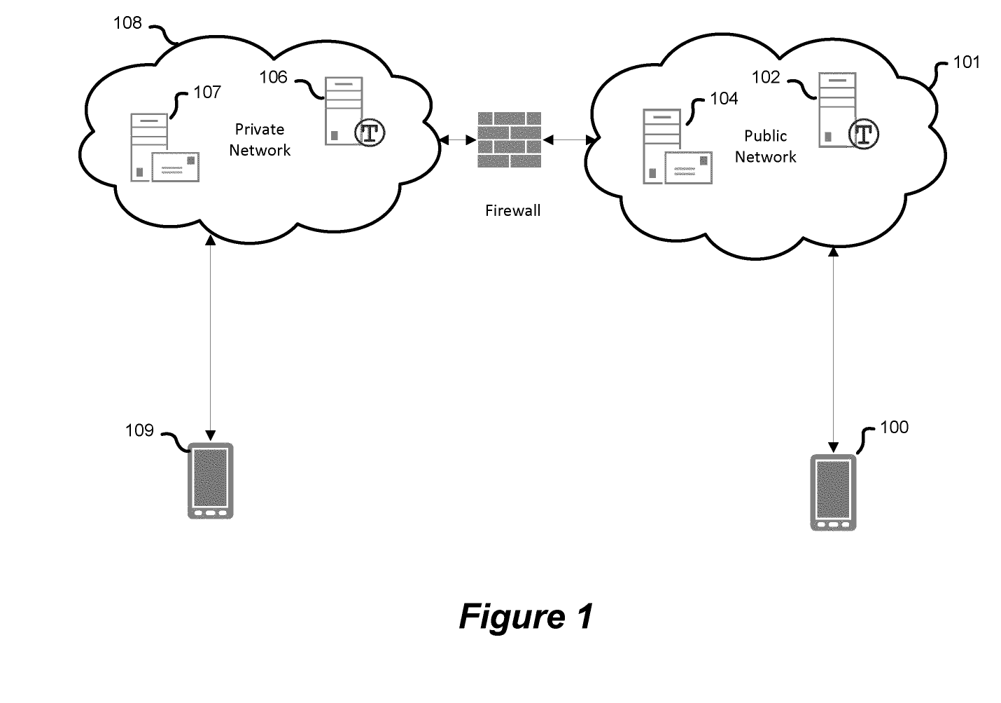

Embodiments are described below, by way of example only, with reference to FIGS. 1-12.

The ease by which personal information can be inadvertently disclosed or potentially intercepted by a third party present significant risk in regards to corporate security, identity theft and maintaining confidential information. The proliferation of mobile devices has increased the possibility of inadvertent data disclosure. Information that can be directly attributable to a user such or be considered confidential to a user is referred to as personally identifiable information (PII). PII is any data that could potentially identify a specific individual or present a risk at allowing a third party to access information by account names or password. personal health information (PHI), also referred to as protected health information, generally refers to demographic information, medical history, test and laboratory results, insurance information and other data related to an individual. PCI (payment card industry) information can be identification of credit card, bank card or band account information. When a mobile device is utilized in a corporate or government function a user may transmit sensitive or confidential information without the appropriate classification and security control being in place or inadvertently send classified information. The ability to control or identify PII, PCI, PHI and confidential information can be difficult in a mobile environment.

This disclosure relates to the use of the virtual keyboard to provide warnings to the user, as well as to communicate classification information to the user, including classification suggestions and methods for the user to participate in the classification process and make classification selections. Referring to FIG. 1, a user operating a mobile device 100 or mobile device 109, such as but not limited to mobile devices such as smartphones and tablets that are capable of creating information, such as emails and documents, connect to a public network 101 or private network 108 to send and receive information. To assist the user in the sending, receiving, composing and consuming email, as well as composing documents there exists) a set of security (sensitive information), PII, PCI (payment card industry), PHI (protected health information) etc. data detection and classification services which are graphically represented on a virtual keyboard on the mobile device 100 or mobile device 109. The set of classification services on virtual keyboard are provided in such a way that they can be accessed on both private and public networks via server, as well as a subset of this offering that can run directly on the mobile devices itself. The classification services can be provided by respective classification server 102 and server 106. The classification server 102 and server 106 can be part of or accessible to mail server 104 or mail server 107. The classification servers can analyze content for keywords, content patterns, contents of an email, recipients of an email or other metadata to provide classification recommendations or provide information or code to the mobile device to facilitate identification and analysis of confidential information, PII, PCI and PHI, which will collectively be referred to as sensitive information.

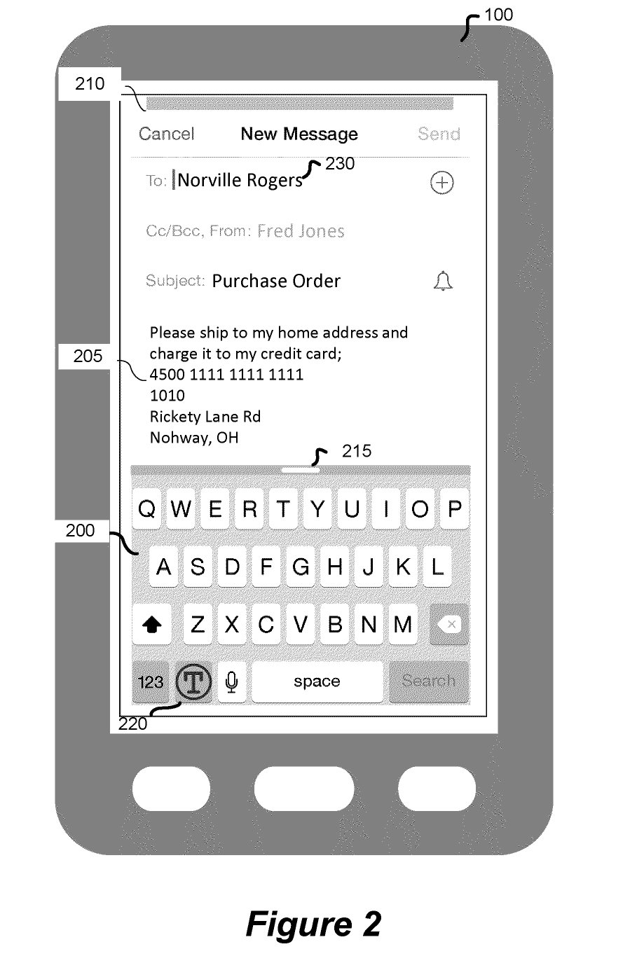

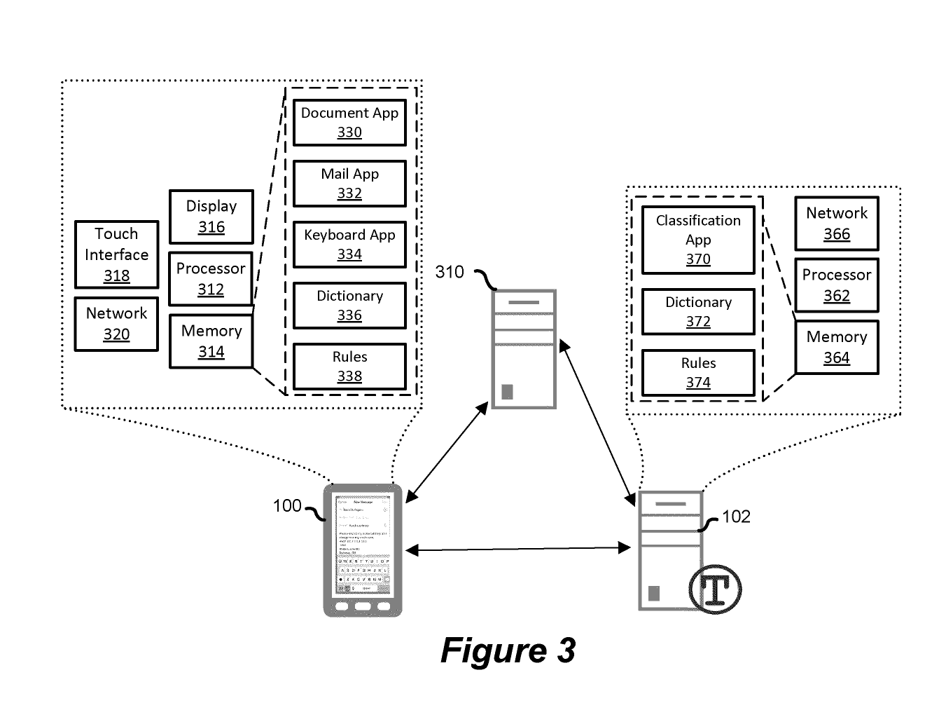

Referring to FIGS. 2 and 3, when a user wishes to enter any type of information the device, the virtual keyboard 200 is displayed within the user interface on the display of the mobile device. A default operating system keyboard is replaced or augmented with the custom virtual keyboard 200 which provides sensitive information, such as security related, PII, PCI, PHI etc. detection and classification functionality in relation to content of a message or document 205 in a text application. As the user is typing the message the custom keyboard engine analyzes, either local to the device or remotely by classification server, the text in order to provide sensitive information detection and auto classification. The sensitive information may be items such as but not limited to addresses, locations, phone numbers, email addresses, financial information, dates, or personal photos. In addition to the text entered by the user, the detection and auto-classification engine can base decisions on attributes about the user 100, the recipients 230 of the email, the device 100, network 101 and the email item 210 are taken into account. Attributes associated with a user can include, but not limited to; nationality, security clearance, job position, role, employment status etc can be determined from an administrator system 310. Attributes associated with the device 100 can include, but not limited to; physical location, safeness of the operating system, device ownership, type of network connectivity etc. The attributes for a network 110, 111 can include, but not limited to; provider, subnet, DNS services, VPN service, level of network security, bandwidth etc. Attributes for an email 210 or document can include, but not limited to; sender, recipients, subject, x-headers, custom x-headers, content, encryption, digital signature, forwarding email servers etc.

The user experience of viewing the warnings or automatically generated or suggested classification can include but is not limited to; visual virtual keyboard cues 220, pop-up messages, changes in text attributes, tactile or auditory cues and or other interactive experiences. In this example a keyboard button 220 is present to allow the use to identify information or may change appearance depending on the detection of classification information. Referring to FIG. 3, the mobile device 100 comprises a processor 312, memory 314, display 316 and touch interface 318. The touch interface 318 can overlay the display 316 which presents a user interface on the mobile device 100. The processor 312 is also connected to a wireless network interface 320 to enable wireless communications with a network. The memory 314 contains instructions which when executed by the processor 312 provides text creation applications executed by the operating system such as a document application 330 or e-mail application 332. As the user is entering text on the device a keyboard 334 is displayed with the user interface which provides classification options and provides processing or analysis of text present in the message. The keyboard application 334 displays a virtual keyboard through integration within the user interface and provides a processing engine for detection of sensitive information within the text creation application. The keyboard application 334 provides identification of sensitive information and provides dynamic classification suggestions within the interface. The keyboard application 334 can utilize a local dictionary 336 or database defining sensitive content keywords, such as names, locations, or data structures, etc. that may convey information of concern. A rules engine 338 can determine combinations of data which may be deemed sensitive in addition to utilize data stored within the device to determine potentially sensitive information. For example the address book stored on the mobile device may be used to map contact information to text entered in the text application. Further, corporate and personal address books may be mapped to determine types of communications which should be deemed sensitive. For example keywords for a project name identified for a corporation may be defined in the dictionary 336 or database, when the project name is used for a message destined for someone within the corporate organization it may be identified for classification, however if the project name is used to someone outside of the organization and is used in a different context, different classifications may be presented. The classification server 102 comprises at least a processor 362, memory 364 and network interface 366. The memory 364 contains instructions which when executed by the processor 362 provide a classification application 370 which receives text from the document application 330 on the mobile device 100. The classification application 370 can utilize a dictionary 372 and rules engine 374 to identify sensitive information within the text. The classification application 370 can define layout of the keyboard or provide information used to define layout and position of classification suggestions within the keyboard 335. Administrator policy information from server 310 may also be utilized to determine what is deemed as sensitive information within an organization. The server 102 can then provide identification of sensitive information to the keyboard application 334 and also provide classifications to be displayed to the user for selection. The keyboard and server may operate in a tandem fashion where the keyboard engine analyzes content and present classifications for known sensitive information. If text content is not with the dictionary or defined in the rules of the keyboard engine the keyboard engine can communicate the content with the server 102 to receive classification options. Alternatively the keyboard 334 may provide all content to the server 102 for processing and identifying classification tags or identifiers to be applied to the content.

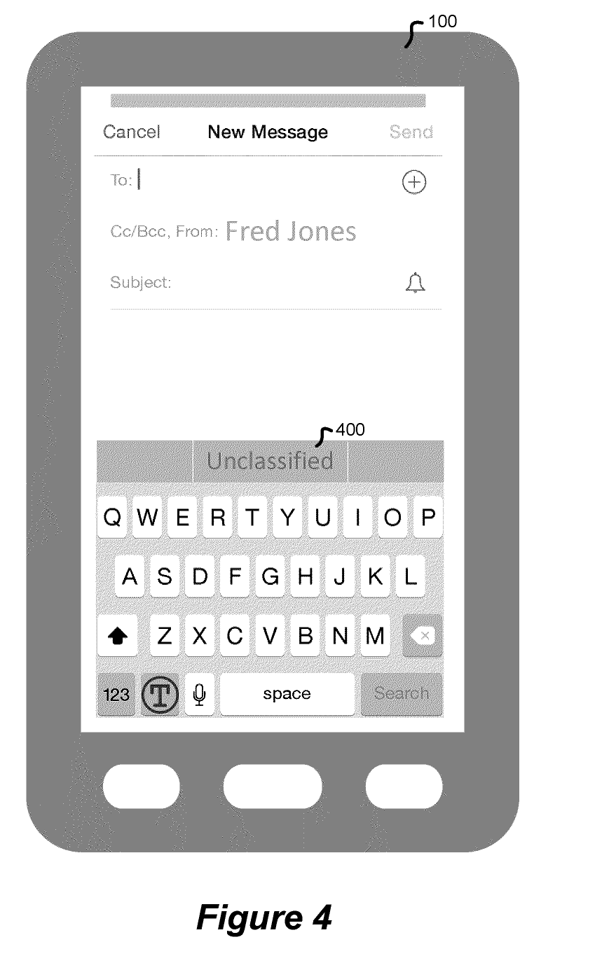

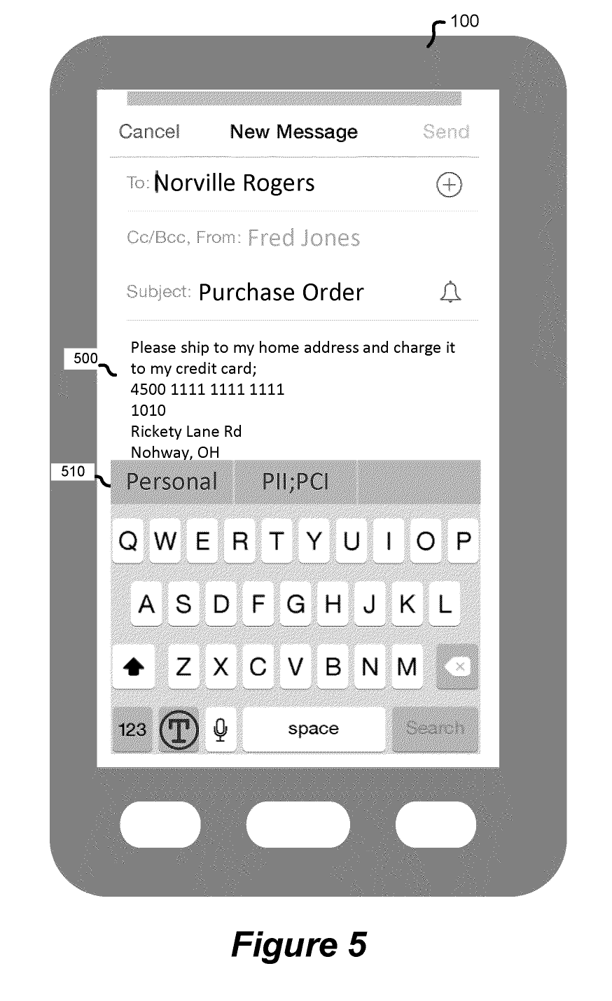

Referring to FIGS. 4 and 5, visual cues that can be presented as part of the keyboard include banner 400 or banner 510 which display possible identification of information types, changes to font or typefaces including emphasis effects on the virtual keyboard, as well as a slowing down the rate at which typed text is displayed in the interface as sensitive information is detected. Tactile cues can include vibrations, changes to the surface of the device including increases/decreases in depth and texturing of the displayed interface. Auditory cues could include sounds that are determined by policy. The suggested classifications presented in the visual cues 400 or banner 510 can change dynamically as the user types or changes the content of the message or as attributes of the message, device or network change dynamically.

As the user is composing the message or document, classification information is displayed based on the message and its context. The classification field displayed is dynamically updated as the message is being created. For instance the message may be originally classified as Public or Unclassified in banner 400, but as the user enters text 500 the message classification displayed in the virtual keyboard 510 may change to Confidential, Secret or others such as Personal and/or PII, PCI, PHI etc. The display of the classification information may also change based upon a position of the cursor, for example classification selections may be identified as credit card information is typed, or just after it is typed, but may also change to present different classification at different positions within the message. The keyboard processes text as entered against a dictionary and rules to determine sensitive information to identify keywords and content patterns and the associated classifications.

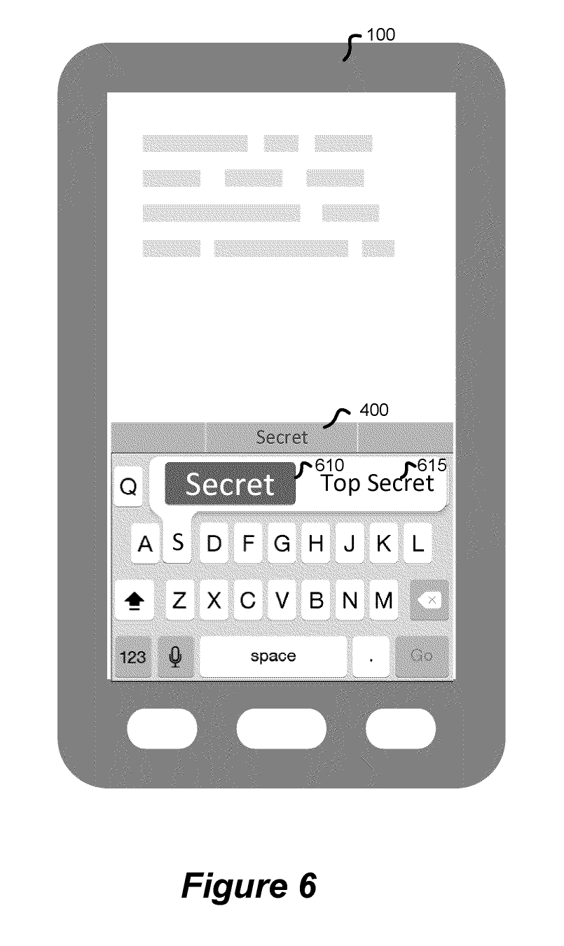

The user's involvement in the classification selection can be configured in a number of different methods. In the first case a) the user has no role in the classification decision. The user can view the classification on the virtual keyboard, but they cannot change the classification displayed 510 and the classification is automatically determined based upon the message or document content. In the second case b) the user can select the classification suggestion 510 or can change the selection to a different classification if they think the automated classification suggestion is not appropriate as shown in FIGS. 6 to 8. The selection for a classification can be selected from the list of available classifications as defined by the classification schema associated with the user or account associated with the user. For example in FIG. 6, the unclassified selection in banner 400 can be changed to Secret 610 where the user can type letters associated with the classification and suggestions ‘secret’ 610 and ‘top secret’ 615 are presented. An alternative method of presenting the classification may be utilized such as selecting the classification entry in the banner, or pop up menu as part of the keyboard interface. When the classification is selected the classification may change the formatting of the content based upon defined classification rules, embed metadata in the document identifying the document as classified or parts of the document as classified or modify HTML properties of the document. The classification selection may also result in encryption being applied to the document or parts thereof before transmission.

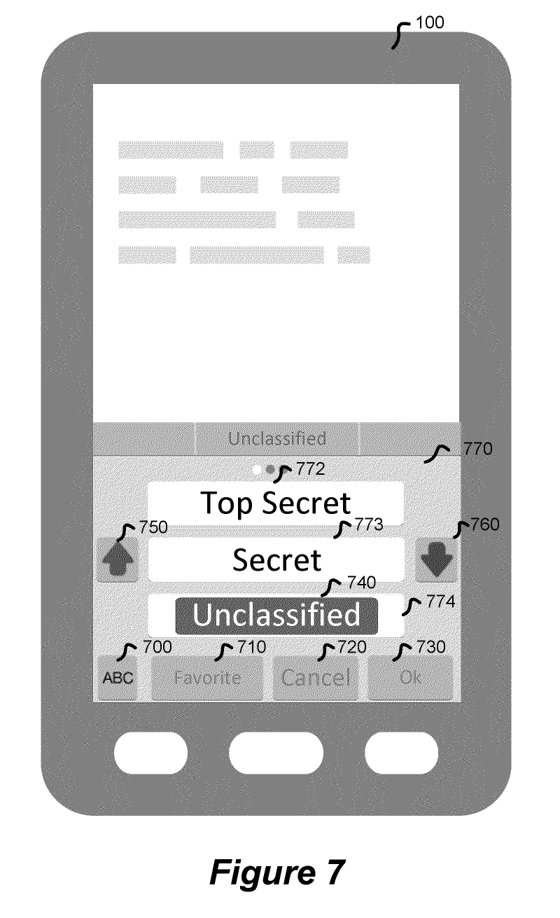

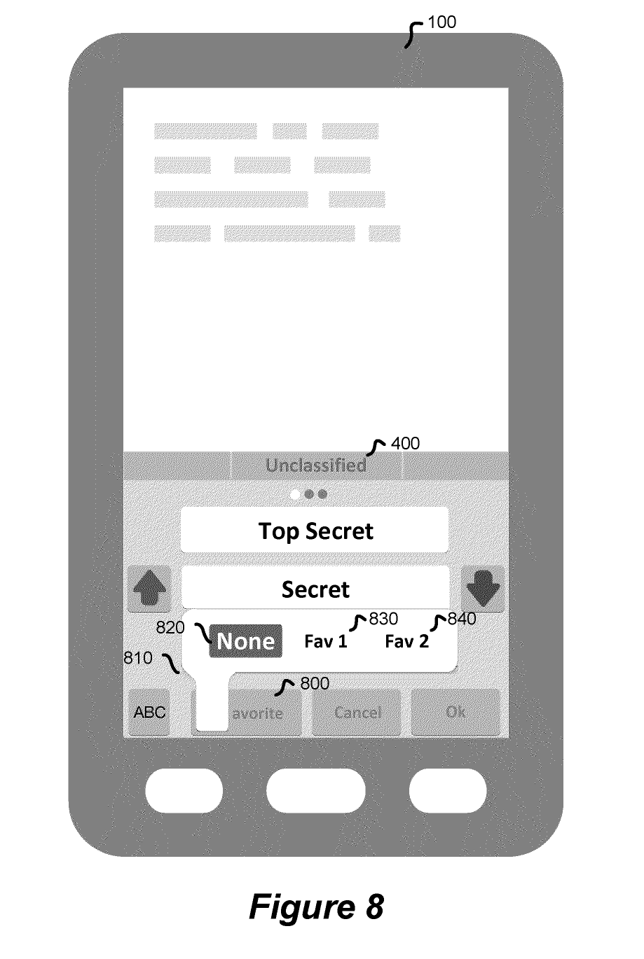

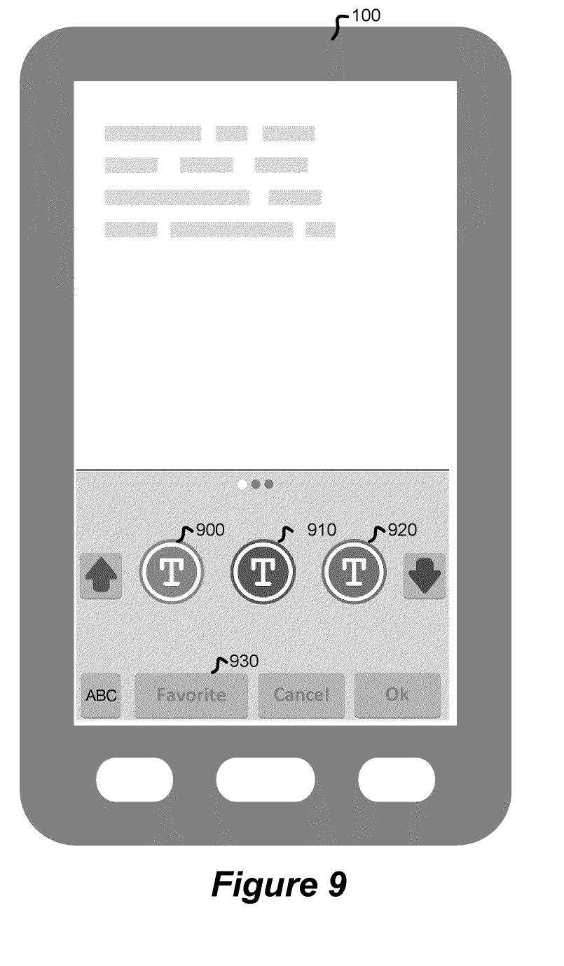

When the user makes a classification selection for a message the classification options can be displayed to the user on the virtual keyboard 770 as shown in FIG. 7. The classification options are displayed as keys on the virtual keyboard 772,773,774 and the user makes a classification selection in the same way they would normally type a letter or symbol on the virtual keyboard. For instance, classification options such as Confidential, Secret, etc would be represented as keys on a virtual keyboard. Additional function keys can be added to the keyboard to downgrade 760 and upgrade the message 750. As well the custom keyboard may contain images that represent classifications 900, 910, 920 as shown in FIG. 9. The pressing of one key as shown in FIG. 6 may invoke a different keyboard layout with additional classifications on it. Based on the user's credentials or identity, the choice of keyboards and keys within those keyboards are configurable by policy. The keyboard arrangement will change, expanding when in landscape mode, and collapsing when in portrait mode. Favourite keys 810, 930 such as shown in FIGS. 8 and 9 can be created that would set a number of classifications with one key press. As shown in FIG. 8 one or more favourites in a selection pop up 810 can be identifying favourites 820, 830, 840. As shown in FIG. 9 the classifications can be associated with color or icons 900, 910 920.

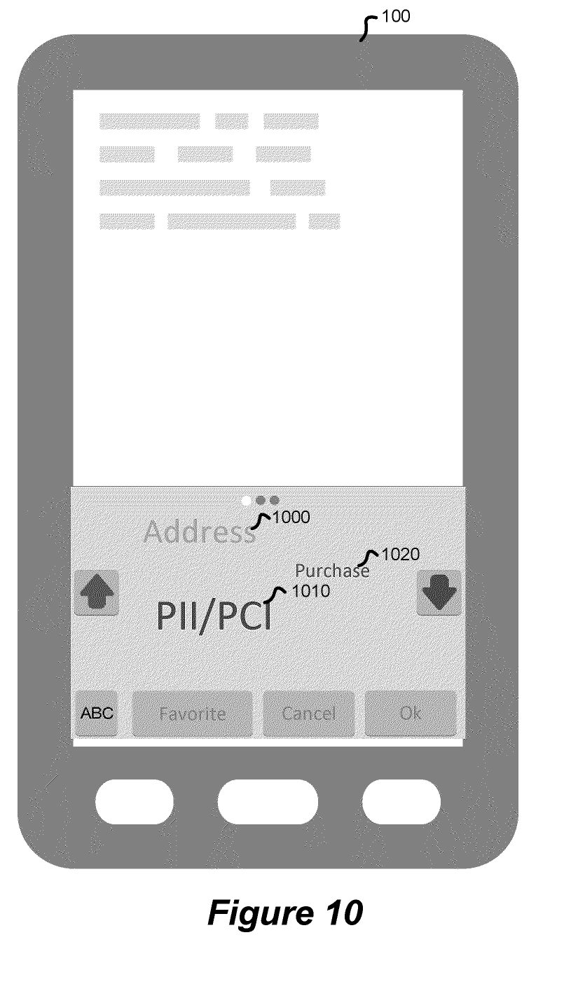

The keys could be re-aligned based on a user definition of being right handed or left handed. That is, keys maybe grouped more closely together depending on your dominate hand. Users can also select tags related to message content or have tags auto selected. Users can select one or multiple tags that apply to the message content. Referring to FIG. 10, the keys on the keyboard may also represent a tag cloud 1000, 1010, 1020 which represent tag possibilities where the size or color represents the possible importance of a tag. These tag keys would be expand and get smaller, change color, change animation, and provide different haptic or tactile feedback to the user. The selection of a tag could lead to the auto generation of additional tag key clouds. After certain selections are made, and a degree of confidence in the user selection or some other terminal state is reached, a classification would be automatically applied to the email

The administrator can create custom keyboards which are provided to the device with custom keys that are associated with a unique Unicode representation. This representation can map to an embedded font or other file to display the images in the display relative to the keys being pressed by the end user. The mapping between key press and Unicode character may represent a text string, or an image or a combination of both. The keyboard may be activated based upon the application.

Certain gesture actions on the keyboard can control the selection of classification. A swipe like motion between the keys could indicate the creation of an ad hoc hierarchy of classifications. Press and holding a key may bring up alternate languages or visual markings associated with that classification. As well, a language key can be locked to a particular language for all the keys, and then unlocked returning them to their default language. The same is true of an alternate visual marking or graphic for the current set of keys.

The relative importance of a key can be attained from its color, location, tactile feel or haptic feedback. Multiple keys can be pressed at once to create a hybrid classification of all the keys pressed. This would be determined by policy.

The custom keyboard will change depending on the schema view being used as defined by the administrator or user. Classification schemas can be defined to match an organization's classification or security requirements.

As the user is composing the message or document, or replying to a message with existing content, the keyboard can also be used to highlight any sensitive information such as security related content, personally identifiable information (PII) or personal health information (PHI) contained in the message. This content is displayed in a special keyboard extension. Via the special keyboard extension the user can be warned that it may be dangerous to send email with PHI or PII, or create and save a document with PII or PHI. For instance, as the user enters PII or PHI text the keyboard may issue sounds, highlight text with color, or slow down input on the keyboard so the user will be aware of the warnings.

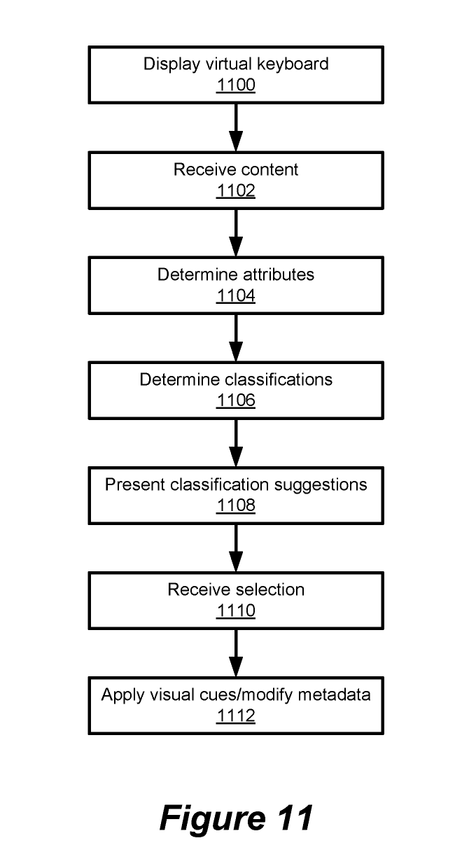

Referring to FIG. 11, a method of automated classification and personally identifiable information and detection using virtual keyboard on a mobile device is described. The virtual keyboard is displayed on a mobile device when a mail or document application is initiated (1100). Content is entered into the application (1102) and sent to a classification server for analysis as it is being entered. Attributes of the message, device, network or user may be associated with the classification and provided with the analysis process (1104). Classifications are presented (1106) either as part of the keyboard layout, a banner, popup or as a selection key associated with the keyboard (1108). The classification may be applied by default, such as for example lowest permissible level or highest required level. A selection may be made by the user (1110) of a particular classification. Classification information can then be applied to a text editing application such as an e-mail message or document either visually or embedded in metadata associated with, or associate to the document (1112). A warning may be presented to the user via virtual keyboard, before sending or saving, preventing the user from sending or saving, changing content via redaction of sensitive material etc. The classified content can be redacted from the message when it is forwarded to a party not having credentials associated with the classification. For example, an email message may have credit card information redacted when it is sent to an outside party.

Alternatively, the keyboard engine may perform all or some of the classification depending on network connectivity, the content of the message, user profile, or application being used to generate the message. The classification may be also be represented by a hash embedded in the message which is identified to the mail or document server which may take actions associated with securing the document or message as the document or message transits the network. The method may be executed by a processor of the mobile device from instructions stored in memory. Portions of the method may be performed by a server accessible to the mobile device through one or more networks. The embedded classification can then be utilized to control the delivery, routing or appearance of the content at the recipient. As part of the classification information may be redacted if it is forward to a 3^{rd} party, or metadata within the message or text may be flagged a personal if user related information is identified. The metadata may alternatively be used to control routing of the message to limit distribution or remove content to different recipients if the recipient security settings does not match metadata information with the text document.

The virtual keyboard may be provided by an application programming interface (API) allowing different keyboards to be used within an application. The classification keyboard can modify or add elements to the keyboard and provide classification selection. The keyboard can communicate with the classification server providing content and attributes for determining the classifications to be presented and associated with the message or document.

The sensitive information classifications may be defined by an organizational security schema, a governmental security schema or user definable schema. The security schema may define classifications that can be used to classify sensitive content to other parties. Sensitive or security information may be defined by privileged or proprietary information which, if compromised through alteration, corruption, loss, misuse, or unauthorized disclosure, could cause serious harm to the organization owning it, also called sensitive asset. The classification information can be associated with the content of the information to ensure proper identification and handling.

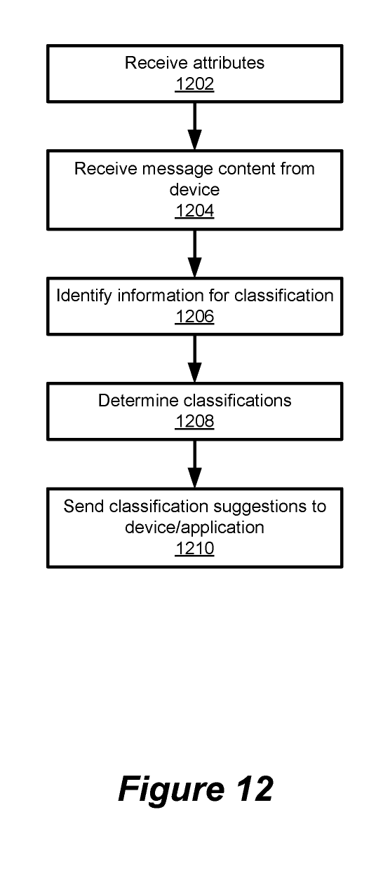

Referring to FIG. 12, a classification server or application may receive attributes providing identification of a user (1202) either by identification of the device or user credentials. Content originating from the device is received at the server as it is being generated by the user (1204) within an application. Content within the message that may be sensitive or provide identification of aspect of the user are identified (1206). The identification of content that requires classification can be performed by dictionary comparison, document signature matching, rule look up for determining for example identifying word or number patterns or comparison to personal information stores on the device such as contacts or banking applications, or corporate classifications. Classification that can be associated with the text can then be determined (1208) based upon the content received at the server. For example if credit card information is identified PCI identification selection may be presented. If a name that is present in an address book is present within the email message but is not a recipient PII classification may be presented. The classification information can be then be sent to the device or application for present, selection and application to the message or document. The classification may be a two-step process where initial classification is performed on the mobile device and the content or text is sent to the server if a match is not determined. The rules may for example define number patterns, such as 16 digit numbers, which may be indicative of credit card information, banking information or social insurance number information. Similarly, the dictionary and rules may define names, locations, projections, clients, customers, matter numbers, patterns or common words that may be deemed sensitive information. Classifications associated with the identified content can also be identified where particular content may have different levels of sensitivity dependent on the context in which it is used. For example, a combination of a person's name and a project name may be flagged as sensitive, whereas if the items are not used in the same message or context they may not be identified. In addition, particular combinations may force classifications to be applied rather than allowing the user to determine a classification.

Although the implementation of automated classification of sensitive content using a virtual keyboard has been described in regards to mobile devices, the implementation is also relevant to any device or software that is capable of email or document creation. For example, where the email client is running on an embedded device or Internet-of-Things enabled device, the same issues still exist, and the methodologies for the user interface are still applicable. The same is true for thicker computing environments and richer email clients operating on general-purpose computing hardware, software and operating system.

Although the description discloses example methods, system and apparatus including, among other components, software executed on hardware, it should be noted that such methods and apparatus are merely illustrative and should not be considered as limiting. It is contemplated that any or all of these hardware and software components could be embodied exclusively in hardware, exclusively in software, exclusively in firmware, or in any combination of hardware, software, and/or firmware. Accordingly, while the following describes example methods and apparatus, persons having ordinary skill in the art will readily appreciate that the examples provided are not the only way to implement such methods and apparatus.

In some embodiments, any suitable computer readable memory can be used for storing instructions for performing the processes described herein. For example, in some embodiments, computer readable media can be transitory or non-transitory. For example, non-transitory computer readable media can include media such as magnetic media (such as hard disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable memory that is not fleeting or devoid of any semblance of permanence during transmission, and/or any suitable tangible media.

1. A method of content classification on a mobile device comprising:
receiving content in a text editing application executed on the mobile device for generating a message or document;
determining one or more classifications associated with sensitive information presented in the content;
modifying a virtual keyboard displayed within the text editing application based upon the determined one or more classifications;
applying at least one of the one or more classifications to the content.

2. The method of claim 1 further comprising sending the content to a server for determining the one or more classifications, wherein the server provides the classifications to the mobile device for display.

3. The method of claim 1 wherein the mobile device determines the classifications by comparing content to a dictionary comprising classification associations.

4. The method of claim 1 or 3 further comprising determining an attribute associated with the mobile device wherein the attribute is used to determine the classification in addition to the content.

5. The method of any one of claims 1 to 4 further comprising determining an attribute associated with a user of the mobile device wherein the attribute is used to determine the classification in addition to the content.

6. The method of any one of claims 1 to 5 further comprising determining an attribute associated with a network to which the mobile device is communicating with wherein the attribute is used to determine the classification in addition to the content.

7. The method of any one of claims 1 to 6 further comprising determining an attribute associated with a recipient of the message or document wherein the attribute is used to determine the classification in addition to the content.

8. The method of any one of claims 1 to 7 wherein the content contains sensitive information associated with personally identifiable information (PII), payment card information (PCI) or personal health information (PHI) wherein the one or more classifications are determined based upon the PII or PHI information.

9. The method of any one of claims 1 to 8 wherein the content contains security classifiable information wherein the one or more classifications are determined based security classifiable information.

10. The method of any one of claims 1 to 9 wherein the one or more classifications are determined based upon one or more keywords present in the content.

11. The method of any one of claims 1 to 10 wherein the classification is applied by visual cues in the message or document.

12. The method of any one of claims 1 to 11 wherein the classification is applied in metadata associated with the message or document.

13. The method of claim 12 wherein the metadata is in HTML format.

14. The method of any one of claims 1 to 13 wherein the classification is identified in a hash associated with the message or document.

15. The method of any one of claims 1 to 14 wherein the classification of the content is at least partially performed on the mobile device.

16. The method of any one of claims 1 to 15 where the classifications presented in the virtual keyboard can be modified by a user.

17. The method of any one of claims 1 to 15 wherein favorite classifications can be determined by a user.

18. The method of any one of claims 1 to 17 wherein possible classifications selections can be presented as any one of text, color, icon, tactile cues or haptic feedback.

19. The method of any one of claims 1 to 18 wherein the classifications are presented as a key of the keyboard.

20. The method of any one of claims 1 to 18 wherein the classifications are presented in a banner.

21. The method of any one of claims 1 to 18 wherein the classifications are presented in a popup within the keyboard.

22. The method of any one of claims 1 to 21 wherein the virtual keyboard can change depending on a schema view being used as defined by an administrator or user.

23. The method of any one of claims 1 to 21 further comprising displaying a warning within the application based upon the determined classification in response to an action to send or save the content.

24. The method of any one of claims 1 to 21 further comprising preventing a user from sending the content or saving the content based upon the determined classification.

25. The method of any one of claims 1 to 24 further comprising preventing a user from sending, saving or changing content via redaction of sensitive material identified in the content.

26. The method of any one of claims 1 to 25 wherein the content is text input.

27. A non-transitory computer readable memory containing instructions for content classification, the instruction which when executed by a processor performing the method of claims 1 to 26.

28. A mobile device containing a processor for performing the method of claims 1 to 27.

29. The mobile device of claims 28, wherein the mobile device is a tablet or smartphone.

30. A classification engine comprising:
a classification database containing a plurality of classifications, each classification associated with a keyword; and
a processing engine for receiving content from a mobile device and determining classifications associated with the content using a classification dictionary the classifications for presentation in a virtual keyboard to be associated with the content.

31. A method of content classification comprising:
receiving content generated from text input on a mobile device;
parsing the content for keywords;
determining classifications associated with the keyword;
providing the classifications to the mobile device for display in a virtual keyboard to be associated with the content.

32. The method of claim 31 further comprising receiving an attribute from the mobile device.

33. The method of claim 31 further comprising sending the content to a server for determining the one or more classifications, wherein the server provides the classifications to the mobile device for display.

34. The method of claim 31 wherein the mobile device determines the classifications by comparing content to a dictionary comprising classification associations.

35. The method of any one of claims 31 to 34 further comprising determining an attribute associated with the mobile device wherein the attribute is used to determine the classification in addition to the content.

36. The method of any one of claims 31 to 35 further comprising determining an attribute associated with a user of the mobile device wherein the attribute is used to determine the classification in addition to the content.

37. The method of any one of claims 31 to 36 further comprising determining an attribute associated with a network to which the mobile device is communicating with wherein the attribute is used to determine the classification in addition to the content.

38. The method of any one of claims 31 to 37 further comprising determining an attribute associated with a recipient of the content wherein the attribute is used to determine the classification in addition to the content.

39. The method of any one of claims 31 to 38 wherein the content contains sensitive information associated with personally identifiable information (PII), payment card information (PCI) or personal health information (PHI) wherein the one or more classifications are determined based upon the PII or PHI information.

40. The method of any one of claims 31 to 39 wherein the content contains security classifiable information wherein the one or more classifications are determined based security classifiable information.

41. The method of any one of claims 31 to 40 wherein the one or more classifications are determined based upon one or more keywords present in the content.

42. The method of any one of claims 31 to 41 wherein the classification is applied by visual cues in the content.

43. The method of any one of claims 31 to 42 wherein the classification is applied in metadata associated with the content.

44. The method of claim 43 wherein the metadata is in HTML format.

45. The method of any one of claims 31 to 44 wherein the classification is identified in a hash associated with the content.

46. The method of any one of claims 31 to 45 wherein the classification of the content is at least partially performed on the mobile device.

47. The method of any one of claims 31 to 46 where the classifications presented in the virtual keyboard can be modified by a user.

48. The method of any one of claims 31 to 46 wherein favorite classifications can be determined by a user.

49. The method of any one of claims 31 to 48 wherein possible classifications selections can be presented as any one of text, color, icon, tactile cues or haptic feedback.

50. The method of any one of claims 31 to 49 wherein the classifications are presented as a key of the keyboard.

51. The method of any one of claims 31 to 50 wherein the classifications are presented in a banner.

52. The method of any one of claims 31 to 51 wherein the classifications are presented in a popup within the keyboard.

53. The method of any one of claims 31 to 52 wherein the virtual keyboard can change depending on a schema view being used as defined by an administrator or user.

54. The method of any one of claims 31 to 52 further comprising displaying a warning within on the mobile device based upon the determined classification in response to an action to send or save the content.

55. The method of any one of claims 31 to 52 further comprising preventing a user from sending the content or saving the content based upon the determined classification.

56. The method of any one of claims 31 to 52 further comprising preventing a user from sending, saving or changing content via redaction of sensitive material identified in the content.

57. The method of any one of claims 31 to 56 wherein the content is text input.

58. A non-transitory computer readable memory containing instructions which when executed by a processor perform the method of claims 31 to 57.
